(19) United States
(12) Patent Application Publication
(10) Pub. No.: US 2012/0162350 A1
(43) Pub. Date: Jun. 28, 2012

(54) AUDIOCONS

(75) Inventors: Justin V. LEE, Berkeley, CA (US); Igal PERELMAN, Oakland, CA (US); Steven A. HALES, Palo Alto, CA (US); Daniel E. STIEFEL, San Francisco, CA (US)

(73) Assignee: VOXER IP LLC, San Francisco, CA (US)

(21) Appl. No.: 13/329,142

(22) Filed: Dec. 16, 2011

Related U.S. Application Data
(60) Provisional application No. 61/424,556, filed on Dec. 17, 2010.

(51) Int. Cl. H04N 7/14

(52) U.S. Cl. 348/14.03; 348/14.01; 348/E07.077

(57) ABSTRACT

A messaging application supports a mode of communication in which users can add audio effects to text messages in order to express emotions. These audio effects are described as audiocons. The audiocons may also alternatively include visual effects. In one implementation the message application supports system-defined audiocons, user-defined audiocons, and text-to-speech audiocons. Additionally, the audiocons may be inserted into a communication stream having a mixture of calls, text messaging, and instant messaging including a system having a real-time mode for time-based media and a time-shifted mode.

### CROSS REFERENCE TO RELATED APPLICATIONS

This application claims priority under 35 U.S.C. 119(e) to U.S. Provisional Patent Application No.: 61/424,556, filed on Dec. 17, 2010, which is incorporated herein by reference in its entirety for all purposes.

### BACKGROUND

1. Field of the Invention

The present invention generally relates to improved emoticons and to their use is a messaging system. In particular, the present invention is directed to the use of system-defined and user-defined audio, video, pictures, and animations to augment text messages and express emotions in a messaging communication application.

2. Description of Related Art

Emoticons are facial expressions pictorially represented by punctuation and letters to represent a writer's mood. There are also various variations on emoticons. Examples include the emoticons described in U.S. Pat. No. 6,987,991, Emoji (Japanese), the proposal of the smiley: http://www.cs.cmu.edu/˜sef/Orig-Smiley.htm, and some ringtones. However, a problem in the prior art is that conventional emoticons are pictorial and typically do not utilize the sense of hearing. More generally, conventional emoticons typically have fixed image representations. Moreover, emoticons are conventionally utilized in messaging platforms by adding them to text messages within the body of the text message (i.e., adding a smiley face emoticon at the end of a text sentence where the recipient views the smiley face at the end of the text message. This limits the ways in which emoticons can be used in communication applications supporting different types of communication modes.

### SUMMARY OF THE INVENTION

The present invention pertains to an improved messaging application and improvements over conventional emoticons. The messaging application is capable of adding system-defined or user-defined media into text message sessions to aid in expressing emotions. The media content added to express emotions may include audio and also user-defined video clips, animation clips, or other audio-visual content to aid in expressing emotions. In one embodiment the media content is generated in a media bubble different than the original text message. In an alternative embodiment, the media content is included in the media bubble containing text. The messaging application may also support calls and text messaging such that the media content added to express emotion is emitted into a message stream having text messages and/or calls.

### BRIEF DESCRIPTION OF THE DRAWINGS

The invention may best be understood by reference to the following description taken in conjunction with the accompanying drawings, which illustrate specific embodiments of the invention.

FIG. 1 is diagram of a non-exclusive embodiment of a communication system embodying the principles of the present invention.

FIG. 2 is a diagram of a non-exclusive embodiment of a communication application embodying the principles of the present invention.

FIG. 3 is an exemplary diagram showing the flow of media on a communication device running the communication application in accordance with the principles of the invention.

FIGS. 4A through 4E illustrate a series of exemplary user interface screens illustrating various features and attributes of the communication application when transmitting media in accordance with the principles of the invention.

FIG. 5 is a flow chart of a method of generating an audiocon in accordance with an embodiment of the invention.

FIG. 6 is a flow chart for a method of generating and using an audiocon in accordance with one embodiment of the present invention.

FIGS. 7A-7C are diagrams illustrating the selection of an audiocon on a communication device in accordance with an embodiment of the invention.

FIG. 8 illustrates several audiocon examples within a conversation string in accordance with one embodiment of the present invention.

FIG. 9 illustrates a flow chart showing how users can create and use custom audiocons in accordance with an embodiment of the invention.

It should be noted that like reference numbers refer to like elements in the figures.

The above-listed figures are illustrative and are provided as merely examples of embodiments for implementing the various principles and features of the present invention. It should be understood that the features and principles of the present invention may be implemented in a variety of other embodiments and the specific embodiments as illustrated in the Figures should in no way be construed as limiting the scope of the invention.

### DETAILED DESCRIPTION OF SPECIFIC EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

An exemplary communication application and communication system for use with the audiocons of the present invention is described in section I of the detailed description. Exemplary audiocon embodiments are described in section II of the detailed description.

### I. Exemplary Communication Application and Communication System

### Media, Messages and Conversations

“Media” as used herein is intended to broadly mean virtually any type of media, such as but not limited to, voice, video, text, still pictures, sensor data, GPS data, or just about any other type of media, data or information. Time-based media is intended to mean any type of media that changes over time, such as voice or video. By way of comparison, media such as text or a photo, is not time-based since this type of media does not change over time.

As used herein, the term “conversation” is also broadly construed. In one embodiment, a conversation is intended to mean a one or more of messages, strung together by some common attribute, such as a subject matter or topic, by name, by participants, by a user group, or some other defined criteria. In another embodiment, the one or more messages of a conversation do not necessarily have to be tied together by some common attribute. Rather, one or more messages may be arbitrarily assembled into a conversation. Thus, a conversation is intended to mean two or more messages, regardless if they are tied together by a common attribute or not.

### System Architecture

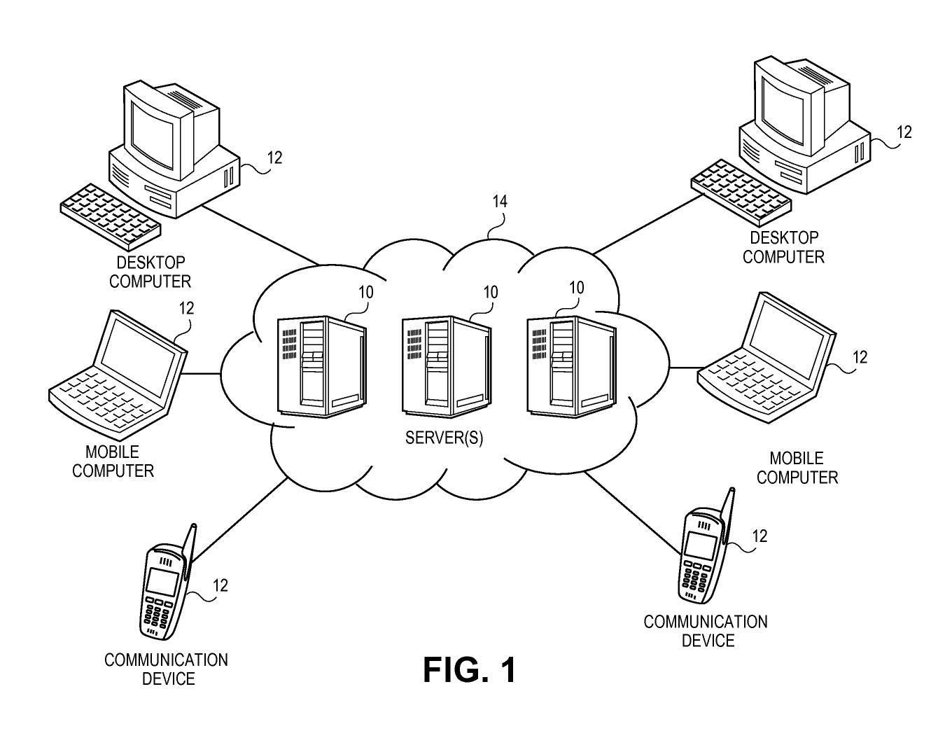

Referring to FIG. 1, an exemplary communication system including one or more communication servers 10 and a plurality of client communication devices 12 is shown. A communication services network 14 is used to interconnect the individual client communication devices 12 through the servers 10.

The server(s) 10 run an application responsible for routing the metadata used to set up and support conversations as well as the actual media of messages of the conversations between the different client communication devices 12. In one specific embodiment, the application is the server application described in commonly assigned co-pending U.S. application Ser. No. 12/028,400 (U.S Patent Publication No. 2009/0003558), Ser. No. 12/192,890 (U.S Patent Publication No. 2009/0103521), and Ser. No. 12/253,833 (U.S Patent Publication No. 2009/0168760), each incorporated by reference herein for all purposes.

The client communication devices 12 may be a wide variety of different types of communication devices, such as desktop computers, mobile or laptop computers, e-readers such as the iPad® by Apple, the Kindle® from Amazon, etc., mobile or cellular phones, Push To Talk (PTT) devices, PTT over Cellular (PoC) devices, radios, satellite phones or radios, VoIP phones, WiFi enabled devices such as the iPod® by Apple, or conventional telephones designed for use over the Public Switched Telephone Network (PSTN). The above list should be construed as exemplary and should not be considered as exhaustive or limiting. Any type of programmable communication device may be used.

The communication services network 14 is IP based and layered over one or more communication networks (not illustrated), such as Public Switched Telephone Network (PSTN), a cellular network based on CDMA or GSM for example, the Internet, a WiFi network, an intranet or private communication network, a tactical radio network, or any other communication network, or any combination thereof. The client communication devices 12 are coupled to the communication services network 14 through any of the above types of networks or a combination thereof. Depending on the type of communication device 12, the connection is either wired (e.g., Ethernet) or wireless (e.g., Wi-Fi, a PTT, satellite, cellular or mobile phone). In various embodiments, the communication services network 14 is either heterogeneous or homogeneous.

### The Communication Application

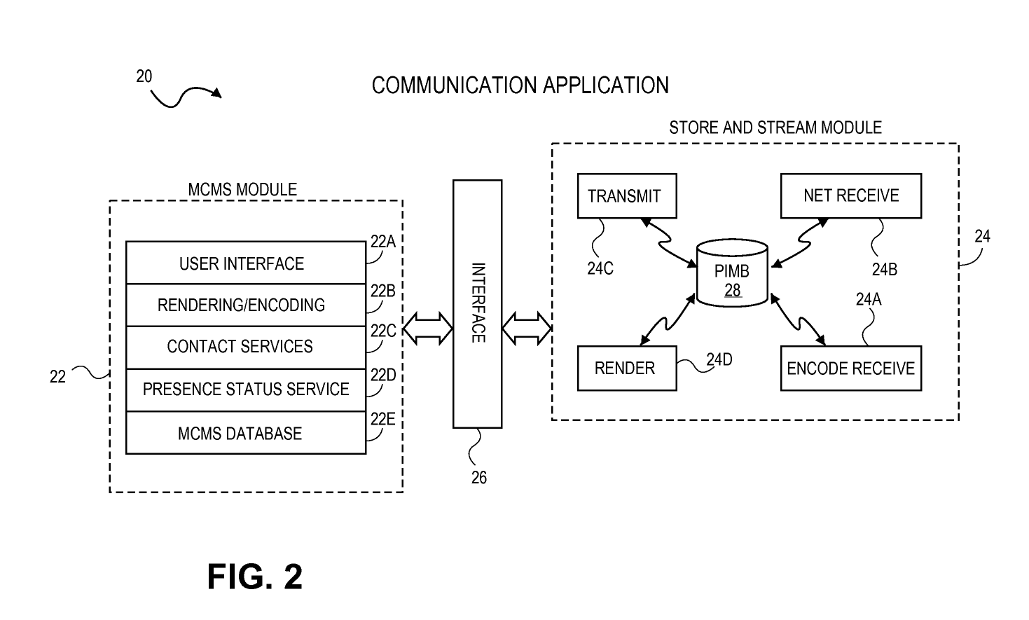

Referring to FIG. 2, a block diagram a communication application 20, which runs on client communication devices 12 is illustrated. The communication application 20 includes a Multiple Conversation Management System (MCMS) module 22, a Store and Stream module 24, and an interface 26 provided between the two modules. The key features and elements of the communication application 20 are briefly described below. For a more detailed explanation, see U.S. application Ser. Nos. 12/028,400, 12/253,833, 12/192,890, and 12/253,820 (U.S Patent Publication No. 2009/0168759), all incorporated by reference herein.

The MCMS module 22 includes a number of modules and services for creating, managing, and conducting multiple conversations. The MCMS module 22 includes a user interface module 22A for supporting the audio and video functions on the client communication device 12, rendering/encoding module 22B for performing rendering and encoding tasks, a contacts service module 22C for managing and maintaining information needed for creating and maintaining contact lists (e.g., telephone numbers, email addresses or other identifiers), and a presence status service module 22D for sharing the online status of the user of the client communication device 12 and which indicates the online status of the other users. The MCMS database 22E stores and manages the metadata for conversations conducted using the client communication device 12.

The Store and Stream module 24 includes a Persistent Infinite Memory Buffer or PIMB 28 for storing, in a time-indexed format, the time-based media of received and sent messages. The Store and Stream module 24 also includes four modules including encode receive 24A, transmit 24C, net receive 24B and render 24D. The function of each module is described below.

The encode receive module 24A performs the function of progressively encoding and persistently storing in the PIMB 28, in the time-indexed format, the media of messages created using the client communication device 12 as the media is created.

The transmit module 24C progressively transmits the media of messages created using the client communication device 12 to other recipients over the network 14 as the media is created and progressively stored in the PIMB 28.

Encode receive module 24A and the transmit module 24C typically, but not always, perform their respective functions at approximately the same time. For example, as a person speaks into their client communication device 12 during a message, the voice media is progressively encoded, persistently stored in the PIMB 28 and transmitted, as the voice media is created. In situations where a message is created while the client communication device 12 is disconnected from the network, the media of the message will be progressively encoded and persistently stored in the PIMB 28, but not transmitted. When the device 12 reconnects to the network, the media of the message is then transmitted out of the PIMB 28.

The net receive module 24B is responsible for progressively storing the media of messages received from others in the PIMB 28 in a time-indexed format as the media is received.

The render module 24D enables the rendering of media either in a near real-time mode or in the time-shifted mode. In the real-time mode, the render module 24D encodes and drives a rendering device as the media of a message is received and stored by the net received module 24B. In the time-shifted mode, the render module 24D retrieves, encodes, and drives the rendering of the media of a previously received message that was stored in the PIMB 28. In the time-shifted mode, the rendered media could be either received media, transmitted media, or both received and transmitted media.

In certain implementations, the PIMB 28 may not be physically large enough to indefinitely store all of the media transmitted and received by a user. The PIMB 28 is therefore configured like a cache, and stores only the most relevant media, while a PIMB located on a server 10 acts as main storage. As physical space in the memory used for the PIMB 28 runs out, select media stored in the PIMB 28 on the client 12 may be replaced using any well-known algorithm, such as least recently used or first-in, first-out. In the event the user wishes to review or transmit replaced media, then the media is progressively retrieved from the server 10 and locally stored in the PIMB 28. The retrieved media is also progressively rendered and/or transmitted as it is received. The retrieval time is ideally minimal so as to be transparent to the user.

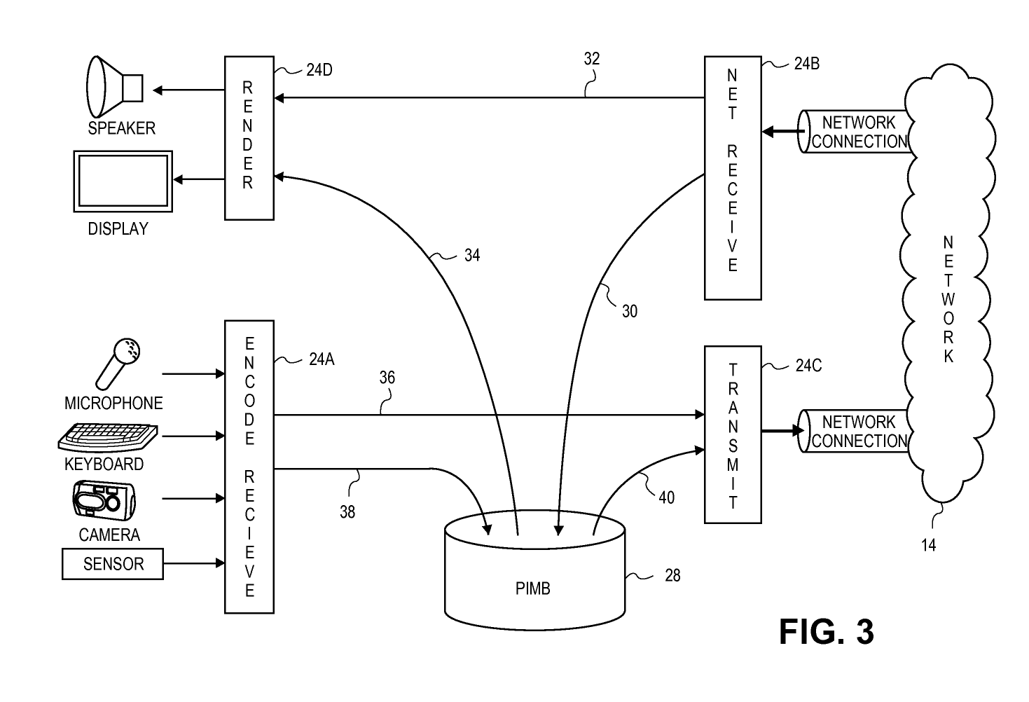

Referring to FIG. 3, a media flow diagram on a communication device 12 running the client application 20 in accordance with the principles of the invention is shown. The diagram illustrates the flow of both the transmission and receipt of media, each in either the real-time mode or the time-shifted mode.

Media received from the communication services network 14 is progressively stored in the PIMB 28 by the net receive module 24B as the media is received, as designated by arrow 30, regardless if the media is to be rendered in real-time or in the time-shifted mode. When in the real-time mode, the media is also progressively provided by the render module 24D, as designed by arrow 32. In the time-shifted mode, the user selects one or more messages to be rendered. In response, the render module 24D retrieves the media of the selected message(s) from the PIMB 28, as designated by arrow 34. In this manner, the recipient may review previously received messages at any arbitrary time in the time-shifted mode.

In most situations, media is transmitted progressively as it is created using a media-creating device (e.g. a microphone, keyboard, video and/or still camera, a sensor such as temperature or GPS, or any combination thereof). As the media is created, it is progressively encoded by encode receive module 24A and then progressively transmitted by transmit module 24C over the network as designed by arrow 36 and progressively stored in the PIMB 28 as designated by arrow 38.

In certain situations, media may be transmitted by transmit module 24C out of the PIMB 28 at some arbitrary time after it was created, as designated by arrow 40. Transmissions out of the PIMB 28 typically occur when media is created while a communication device 12 is disconnected from the network 14. When the device 12 reconnects, the media is progressively read from the PIMB 28 and transmitted by the transmit module 24C.

With conventional “live” communication systems, media is transient, meaning media is temporarily buffered until it is either transmitted or rendered. After being either transmitted or rendered, the media is typically not stored and is irretrievably lost.

With the application 20 on the other hand, transmitted and received media is persistently stored in the PIMB 28 for later retrieval and rendering in the time-shifted mode. In various embodiments, media may be persistently stored indefinitely, or periodically deleted from the PIMB 28 using any one of a variety of known deletion policies. Thus the duration of persistent storage may vary. Consequently, as used herein, the term persistent storage is intended to be broadly construed and mean the storage of media and meta data from indefinitely to any period of time longer than transient storage needed to either transmit or render media in real-time.

As a clarification, the media creating devices (e.g., microphone, camera, keyboard, etc.) and media rendering devices as illustrated are intended to be symbolic. It should be understood such devices are typically embedded in certain devices 12, such as mobile or cellular phones, radios, mobile computers, etc. With other types of communication devices 12, such as desktop computers, the media rendering or generating devices may be either embedded in or plug-in accessories.

### Operation of the Communication Application

The client application 20 is a messaging application that that allows users to transmit and receive messages. With the persistent storage of received messages, and various rendering options, a recipient has the ability to render incoming messages either in real-time as the message is received or in a time-shifted mode by rendering the message out of storage. The rendering options also provide the ability to seamlessly shift the rendering of a received message between the two modes.

The application 20 is also capable of transmitting and receiving the media of messages at the same time. Consequently, when two (or more) parties are sending messages to each other at approximately the same time, the user experience is similar to a synchronous, full-duplex, telephone call. Alternatively, when messages are sent back and forth at discrete times, the user experience is similar to an asynchronous, half-duplex, messaging system.

The application 20 is also capable of progressively transmitting the media of a previously created message out of the PIMB 28. With previously created messages, the media is transmitted in real-time as it is retrieved from the PIMB 28. Thus, the rendering of messages in the real-time may or may not be live, depending on if the media is being transmitted as it is created, or if was previously created and transmitted out of storage.

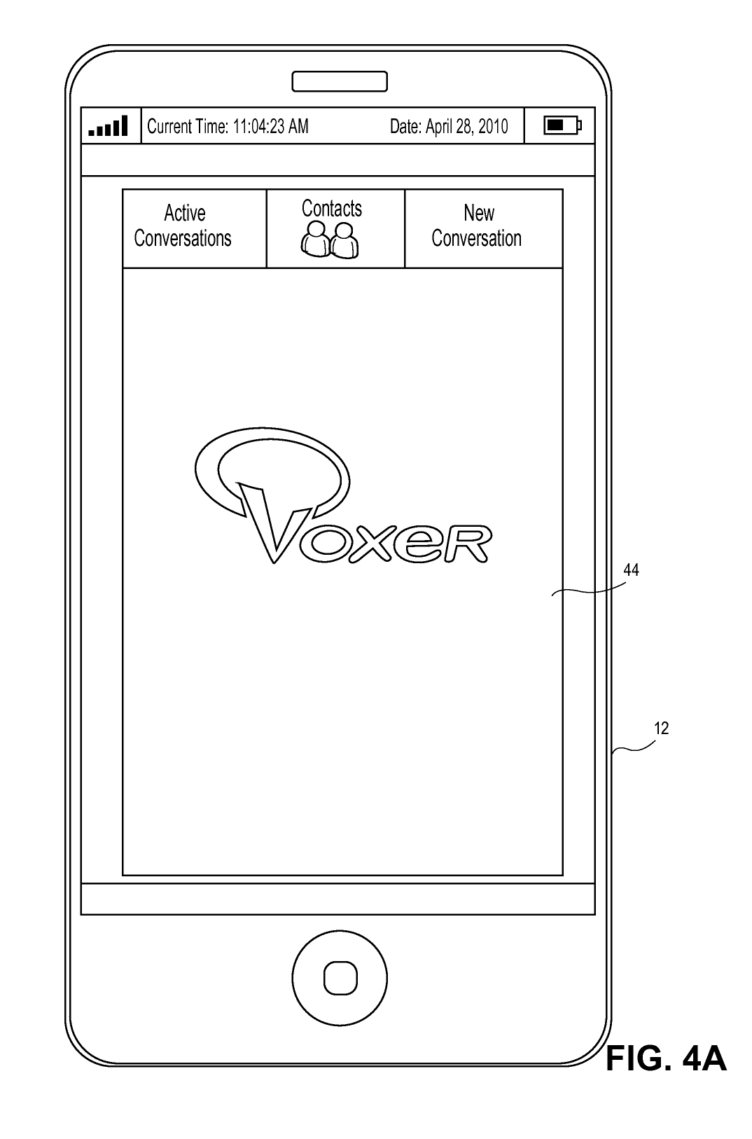

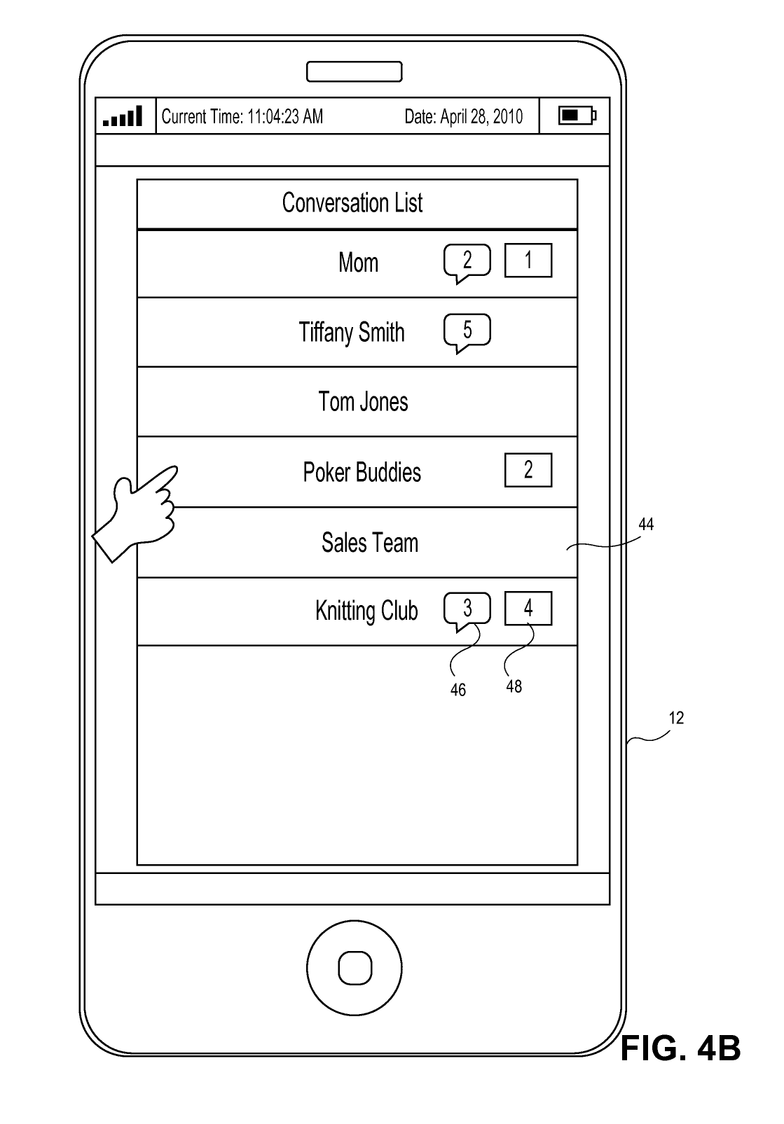

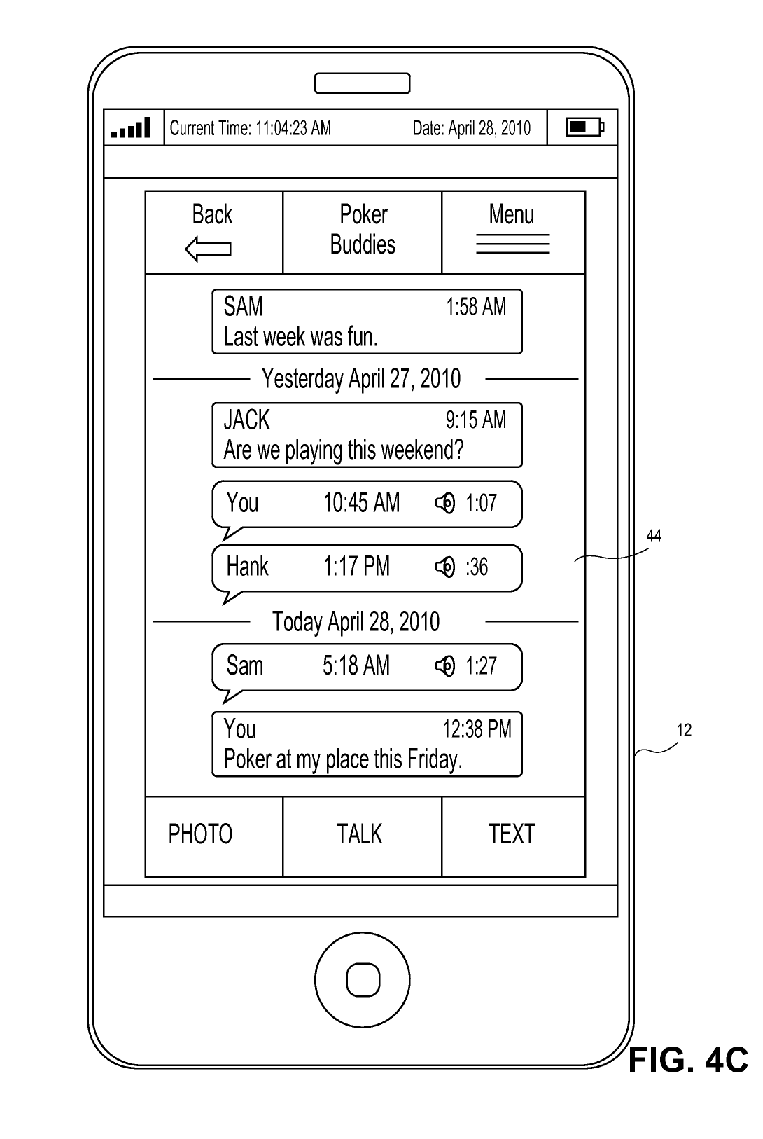

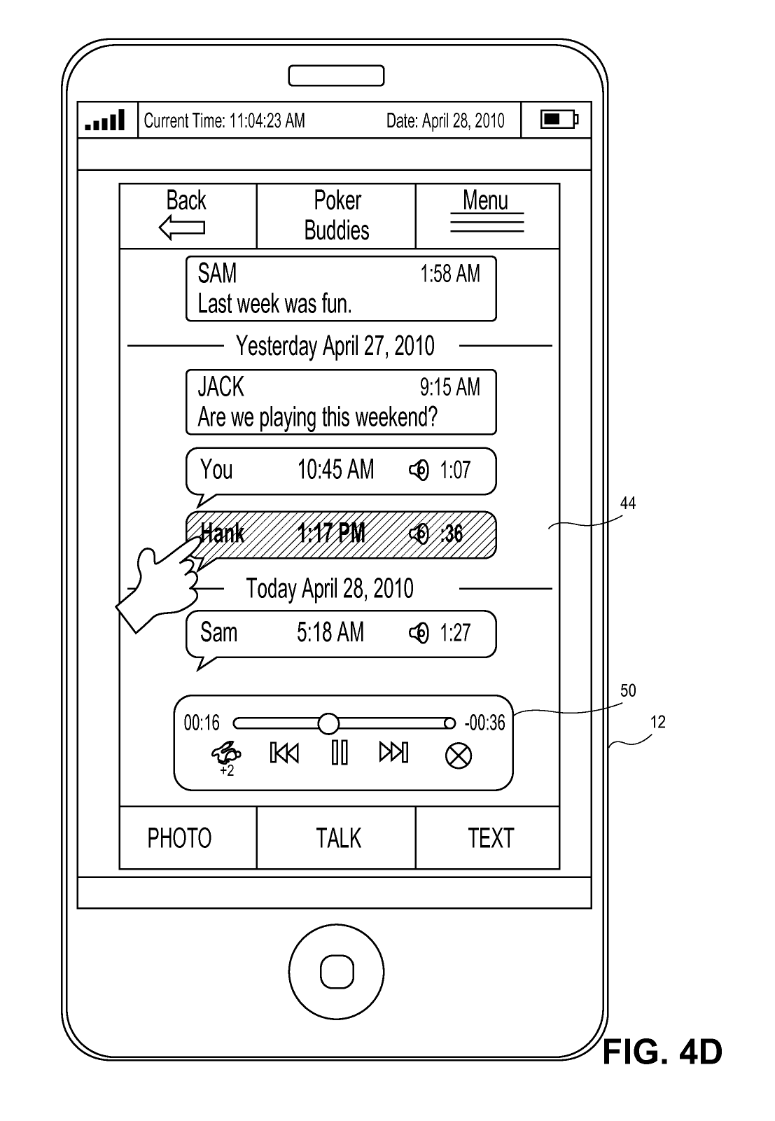

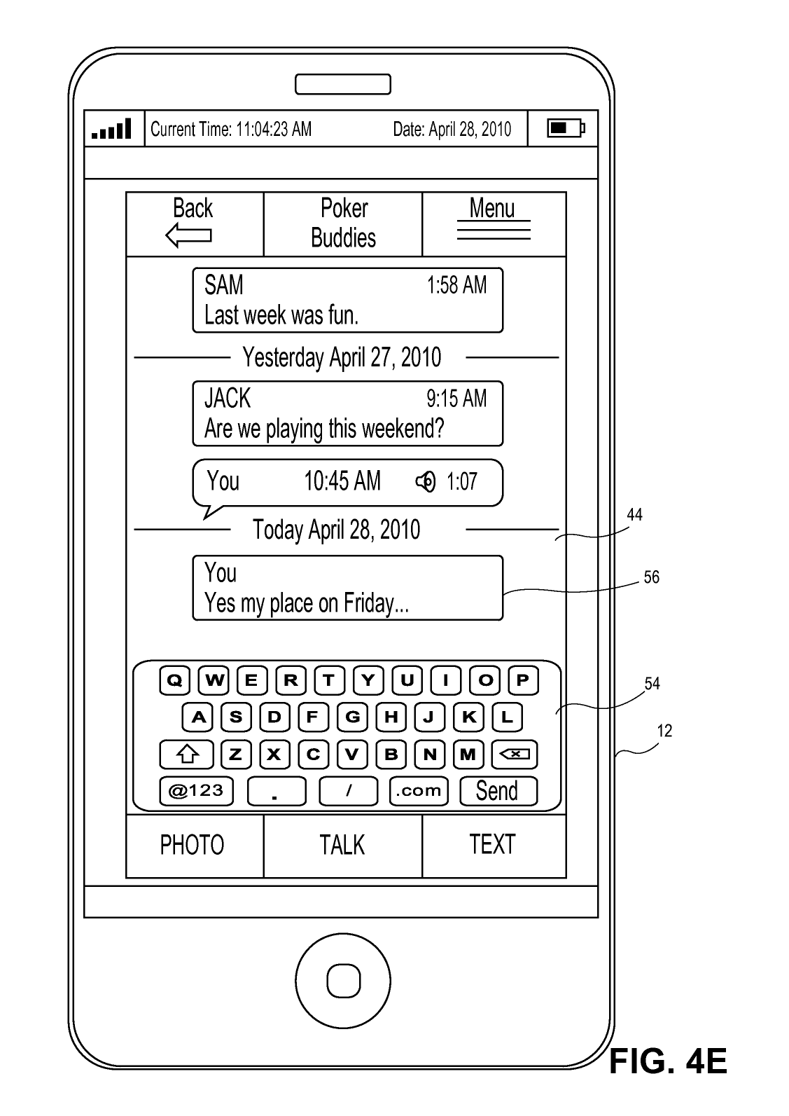

Referring to FIGS. 4A through 4G, a series of exemplary user interface screens appearing on the display 44 on a mobile communication device 12 are illustrated. The user interface screens provided in FIGS. 4A through 4G are useful for describing various features and attributes of the application 20 when transmitting media to other participants of a conversation.

Referring to FIG. 4A, an exemplary home screen appearing on the display 44 of a mobile communication device 12 running the application 20 is shown. In this example, the application 20 is the Voxer® communication application owned by the assignee of the present application. The home screen provides icons for “Contacts” management, creating a “New Conversation,” and a list of “Active Conversations.” When the Contacts icon is selected, the user of the device 12 may add, delete or update their contacts list. When the Active Conversations input is selected, a list of the active conversations of the user appears on the display 44. When the New Conversation icon is selected, the user may define the participants and a name for a new conversation, which is then added to the active conversation list.

Referring to FIG. 4B, an exemplary list of active conversations is provided in the display 44 after the user selects the Active Conversations icon. In this example, the user has a total of six active conversations, including three conversations with individuals (Mom, Tiffany Smith and Tom Jones) and three with user groups (Poker Buddies, Sales Team and Knitting Club).

Any voice messages or text messages that have not yet been reviewed for a particular conversation appear in a voice media bubble 46 or text media rectangle 48 appearing next to the conversation name respectively. With the Knitting Club conversation for example, the user of the device 12 has not yet reviewed three (3) voice messages and four (4) text messages.

As illustrated in FIG. 4C, the message history of a selected conversation appears on the display 44 when one of the conversations is selected, as designated by the hand selecting the Poker Buddies conversation in FIG. 4B. The message history includes a number of media bubbles displayed in the time-index order in which they were created. The media bubbles for text messages include the name of the participant that created message, the actual text message (or a portion thereof) and the date/time it was sent. The media bubbles for voice messages include the name of the participant that created the message, the duration of the message, and the date/time it was sent.

When any bubble is selected, the corresponding media is retrieved from the PIMB 28 and rendered on the device 12. With text bubbles, the entire text message is rendered on the display 44. With voice and/or video bubbles, the media is rendered by the speakers and/or on the display 44.

The user also has the ability to scroll up and/or down through all the media bubbles of the selected conversation. By doing so, the user may select and review any of the messages of the conversation at any arbitrary time in the time-shifted mode. Different user-interface techniques, such as shading or using different colors, bolding, etc., may also be used to contrast messages that have previously been reviewed with messages that have not yet been reviewed.

Referring to FIG. 4D, an exemplary user interface on display 44 is shown after the selection of a voice media bubble. In this example, a voice message by a participant named Hank is selected. With the selection, a media rendering control window 50 appears on the display 44. The render control window 50 includes a number of rendering control options, as described in more detail below, that allow the user of the device 12 to control the rendering of the media contained in the message from Hank.

With the Talk or Text options, the intent of the user is to send either an voice or text message to the other participants of the conversation.

In one embodiment, as illustrated, the Talk icon operates similar to a Push To Talk (PTT) radio, where the user selects and holds the icon while speaking. When done, the user releases the icon, signifying the end of the message. In a second embodiment (not illustrated), Start and Stop icons may appear in the user interface on display 44. To begin a message, the Start icon is selected and the user begins speaking. When done, the Stop icon is selected. In a third embodiment, which is essentially a combination of the previous two, the Messaging icon is selected a first time to begin the message, and then selected a second time to end the message. This embodiment differs from the first “PTT” embodiment because the user is not required to hold the Messaging icon for the duration of the message. Regardless of which embodiment is used, the media of the outgoing message is progressively stored in the PIMB 28 and transmitted to the other participants of the Poker Buddies conversation as the media is created.

FIG. 4E illustrates an exemplary user interface when the Text option is selected. With this option, a keyboard 54 appears on the user interface on display 44. As the user types the text message, it appears in a text media bubble 56. When the message is complete, it is transmitted to the other participants by the “Send” function on the keyboard 54. In other types of communication devices 12 having a built-in keyboard or a peripheral keyboard, a keyboard 54 will typically not appear on the display 44 as illustrated. Regardless of how the keyboard function is implemented, the media bubble including the text message is included in the conversation history in time-indexed order after it is transmitted.

The above-described user interface of client application 20 should be construed as exemplary and not limiting in any manner For example, the “Talk” feature can be modified to be a “Push to Talk” option. In either case, messages are transmitted in real-time as the media is created. On the receive side, the recipient can elect to review or screen the media as the message is received in real time, review the message asynchronously at a later time, or respond by selecting the “Push to Talk” or “Talk” function on their device. When both parties are transmitting outgoing messages and rendering incoming messages at approximately the same time, the user experience is very similar to a full duplex telephone call. When messages are sent and reviewed at discrete times, the user experience is similar to a half-duplex, asynchronous, messaging system.

### Rendering Controls

In various situations, the media rendering control window 50 appears on the display 44, as noted above. The rendering options provided in the window 50 may include, but are not limited to, play, pause, replay, play faster, play slower, jump backward, jump forward, catch up to the most recently received media or Catch up to Live (CTL), or jump to the most recently received media. The latter two rendering options are implemented by the “rabbit” icon, which allows the user to control the rendering of media either faster (e.g., +2, +3. +4) or slower (e.g., −2, −3, −4) than the media was originally encoded. As described in more detail below, the storage of media and certain rendering options allow the participants of a conversation to seamlessly transition the rendering of messages and conversations from a time-shifted mode to the real-time mode and vice versa.

### Transmission Out of Storage

With the persistent storage of transmitted and received media of conversations in the PIMB 28, a number of options for enabling communication when a communication device 12 is disconnected from the network 14 are possible. When a device 12 is disconnected from the network 14, for example when a cell phone roams out of network range, the user can still create messages, which are stored in the PIMB 28. When the device 12 re-connects to the network 14, when roaming back into network range, the messages may be automatically transmitted out of the PIMB 28 to the intended recipient(s). Alternatively, previously received messages may also be reviewed when disconnected from the network, assuming the media is locally stored in the PIMB 28. For more details on these features, see U.S. application Ser. Nos. 12/767,714 and 12/767,730, both filed Apr. 26, 2010, commonly assigned to the assignee of the present application, and both incorporated by reference herein for all purposes.

It should be noted that the look and feel of the user interface screens as illustrated are merely exemplary and have been used to illustrate certain operations characteristic of the application 20. In no way should these examples be construed as limiting. In addition, the various conversations used above as examples primarily included voice media and/or text media. It should be understood that conversations may also include other types of media, such a video, audio, GPS or sensor data, etc. It should also be understood that certain types of media may be translated, transcribed or otherwise processed. For example, a voice message in English may be translated into another language or transcribed into text, or vice versa. GPS information can be used to generated maps or raw sensor data can be tabulated into tables or charts for example.

### Real-Time Communication Protocols

In various embodiments, the communication application 20 may rely on a number of real-time communication protocols. In one optional embodiment, a combination of a loss tolerant (e.g., UDP) and a network efficient protocol (e.g., TCP) are used. The loss tolerant protocol is used only when transmitting time-based media that is being consumed in real-time and the conditions on the network are inadequate to support a transmission rate sufficient to support the real-time consumption of the media using the network efficient protocol. On the other hand, the network efficient protocol is used when (i) network conditions are good enough for real-time consumption or (ii) for the retransmission of missing or all of the time-based media previously sent using the loss tolerant protocol. With the retransmission, both sending and receiving devices maintain synchronized or complete copies of the media of transmitted and received messages in the PIMB 28 on each device 12 respectively. For details regarding this embodiment, see U.S. application Ser. Nos. 12/792,680 and 12/792,668 both filed on Jun. 2, 2010 and both incorporated by reference herein.

In another optional embodiment, the Cooperative Transmission Protocol (CTP) for near real-time communication is used, as described in U.S application Ser. Nos. 12/192,890 and 12/192,899 (U.S Patent Publication Nos. 2009/0103521 and 2009/0103560), all incorporated by reference herein for all purposes. With CTP, the network is monitored to determine if conditions are adequate to transmit time-based media at a rate sufficient for the recipient to consume the media in real-time. If not, steps are taken to generate and transmit on the fly a reduced bit rate version of the media for the purpose of enhancing the ability of the recipient to review the media in real-time, while background steps are taken to ensure that the receiving device 12 eventually receives a complete or synchronized copy of the transmitted media.

In yet another optional embodiment, a synchronization protocol may be used that maintains synchronized copies of the time-based media of transmitted and received messages sent between sending and receiving communication devices 12, as well as any intermediate server 10 hops on the network 14. See for example U.S. application Ser. Nos. 12/253,833 and 12/253,837, both incorporated by reference herein for all purposes, for more details.

In various other embodiments, the communication application 20 may rely on other real-time transmission protocols, including for example SIP, RTP, and Skype®.

Other protocols, which previously have not been used for the live transmission of time-based media as it is created, may also be used. Examples may include HTTP and both proprietary and non-proprietary email protocols, as described below.

### Addressing and Message Routing

If the user of a communication device 12 wishes to communicate with a particular recipient, the user will either select the recipient from their list of contacts or reply to an already received message from the intended recipient. In either case, an identifier associated with the recipient is defined. Alternatively, the user may manually enter an identifier identifying a recipient. In some embodiments, a globally unique identifier, such as a telephone number or email address, may be used. In other embodiments, non-global identifiers may be used. Within an online web community for example, such as a social networking website, an identifier may be issued to each member or a group identifier may issued to a group of individuals within the community. This identifier may be used for both authentication and the routing of media among members of the web community. Such identifiers are generally not global because they cannot be used to address an intended recipient outside of the web community. Accordingly the term “identifier” as used herein is intended to be broadly construed and mean both globally and non-globally unique identifiers.

When a message is created on a client device 12, the identifier is inserted into a message header. As soon as the identifier is defined, the message header is immediately to the server(s) 10 on the network 14, ahead of the message body containing the media of the message. In response, the server(s) 10 determine based on the identifier (i) if the recipient is currently connected to the network, and if so (ii), at least a partial delivery path for delivering the message to a device associated with the recipient. As a result, as the media of the message in the message body is progressively transmitted to the server(s) 10, the media is progressively routed to the device associated with the recipient as the delivery route is discovered. For more details on message addressing and routing, see for example U.S. application Ser. No. 12/419,914 and U.S. application Ser. No. 12/552,980, both assigned to assignee of the present application and incorporated herein for all purposes.

### HTTP

In yet another embodiment, the HTTP protocol has been modified so that a single HTTP message may be used for the progressive real-time transmission of live or previously stored time-based media as the time-based media is created or retrieved from storage. This feature is accomplished by separating the header from the body of HTTP messages. By separating the two, the body of an HTTP message no longer has to be attached to and transmitted together with the header. Rather, the header of an HTTP message may be transmitted immediately as the header information is defined, ahead of the body of the message. In addition, the body of the HTTP message is not static, but rather is dynamic, meaning as time-based media is created, it is progressively added to the HTTP body. As a result, time-based media of the HTTP body may be progressively transmitted along a delivery path discovered using header information contained in the previously sent HTTP header.

In one non-exclusive embodiment, HTTP messages are used to support “live” communication. The routing of an HTTP message starts as soon as the HTTP header information is defined. By initiating the routing of the message immediately after the routing information is defined, the media associated with the message and contained in the body is progressively forwarded to the recipient(s) as it is created and before the media of the message is complete. As a result, the recipient may render the media of the incoming HTTP message live as the media is created and transmitted by the sender. For more details on using HTTP, see U.S. provisional application 61/323,609 filed Apr. 13, 2010, incorporated by reference herein for all purposes.

### Web Browser Embodiment

In yet another embodiment, the messaging application 20 is configured as a web application that is served by a web server. When accessed, the communication application 20 is configured to create a user interface appearing within one or more web pages generated by a web browser running on the communication device 12. Accordingly, when the user interface for application 20 appears on the display 44, it is typically within the context of a web page, such as an on-line social networking, gaming, dating, financial or stock trading, or any other on-line community. The user of the communication device 12 can then conduct conversations with other members of the web community through the user interface within the web site appearing within the browser. For more details on the web browser embodiment, see U.S. application Ser. No. 12/883,116 filed Sep. 15, 2010, assigned to the assignee of the present application, and incorporated by reference herein.

### II. Audiocon Embodiments

In one embodiment the communication application 20 is adapted to further include audiocons supported by the database, interface, and rendering features of MCMS module 22 and store and stream module 24. That is, the audiocons may be generated, transmitted, and received by a recipient system using features previously described in regard to generating, transmitting, and receiving text and media. Thus, the audiocons may be inserted into an interactive communication stream including one or more messages containing streaming voice and/or video, as well as other time-based media, in addition to text messages, in order to aid in expressing emotions or other audio and/or video content.

In one embodiment, audiocons enable users to express thoughts, feelings, and emotions by injecting an audio and/or audio-visual element into an interactive communication stream. For example, an audiocon including the sounds of a person crying or sobbing would be used to express the emotion of sadness. Alternatively, the sound of laughter would be used to express happiness, etc. In other embodiments, however, audiocons can be used to create special effects that are not necessarily based on an emotion. For example, an audiocon including the sound of a honking horn, a bomb exploding, rain, etc. may be used to convey a particular audio and/or visual expression that is somehow relevant to an ongoing conversation. Consequently, the term audiocon as used herein should be broadly construed to generally mean a variety of different types of media files including audio, text, visual material, such as pictures, video clips, or animation clips that are included in a media bubble.

In various embodiments, audiocons can be selected and inserted into a conversation string in a variety of different ways. In a first embodiment, for example, an audiocon can be selected from the entry of a predefined string of text characters between start and end deliminators. In another embodiment, a user can select an “Audiocon” input function, which causes the display of a library of audiocons. With the selection of one or more of the audiocons, the corresponding media is automatically inserted into a media bubble of the conversation string.

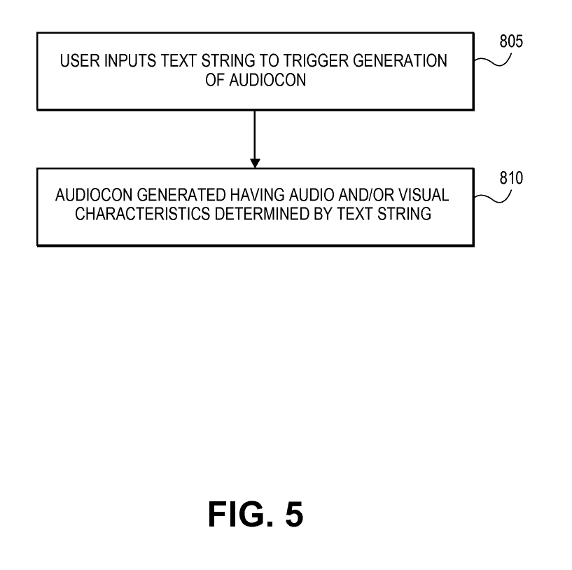

Referring to FIG. 5, a flow chart illustrating the steps for the text entry of an audiocon is illustrated. Initially, a user inputs a predefined text string to trigger the generation of an audiocon (step 805). An audiocon is then generated in response having audio and/or audio-visual characteristics determined by the predefined text string (step 810).

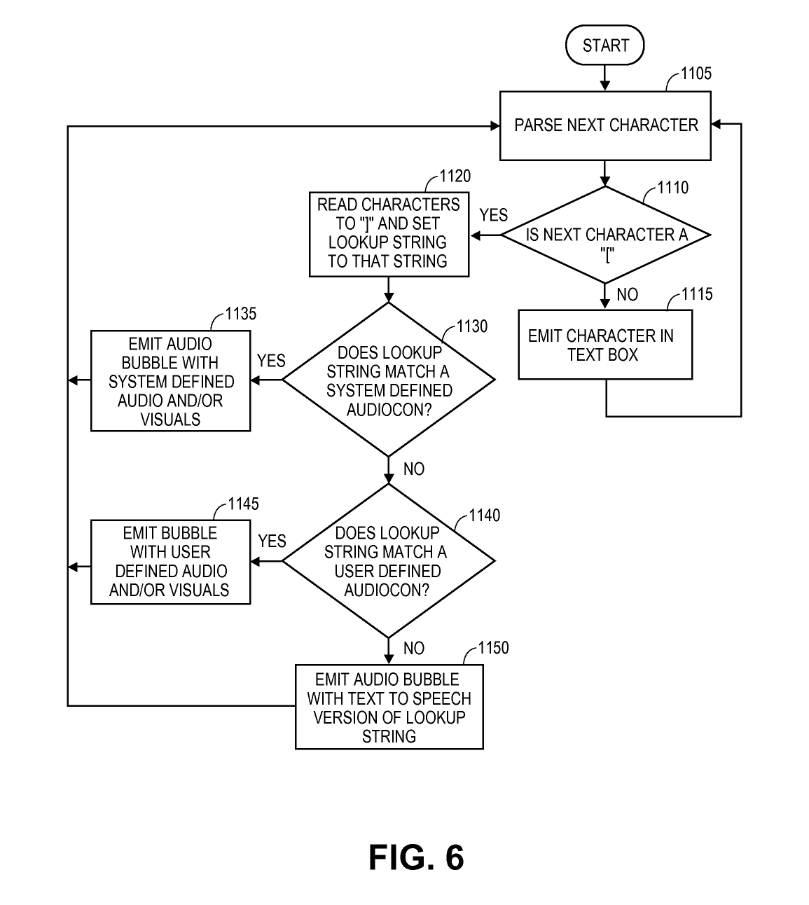

FIG. 6 illustrates a flowchart for an exemplary method of inputting an audiocon using a predefined text string in accordance with an embodiment of the present invention. Characters of a text string are parsed (step 1105). This may, for example, be done sequentially. A decision is made in decision block 1110 whether the next character is the start delimiter (e.g., “[”) indicating the start of an audiocon text string. If it isn't then the character is emitted into a text block (step 1115) as a conventional text character. If the next character is the start delimiter then all of the characters are read until the end of the stop delimiter (e.g., “]”) and set as the lookup string (step 1120).

A determination is made (step 1130) if the lookup string matches a system defined audiocon. If the lookup string matches the system defined audiocon then a bubble is emitted with system defined audio and/or visuals (step 1135). If the audiocon text string is a known, system-defined string (e.g., [cheers]), then an additional audio bubble can be emitted into the conversation stream that is the audio string (e.g., sound of a crowd cheering) associated with the system defined string.

The string lookup checking otherwise continues to determine (step 1140) if the looking string matches a user-defined audiocon. If the lookup string matches a user-defined audiocon then a bubble is emitted with user-defined audio and/or visuals (step 1145). That is, if the audiocon string is a user-defined string for this user, then an additional audio bubble can be emitted in to the conversation stream that is the audio associated (by this user) with that string. In one embodiment user can customize the audio for the audiocon by selecting a sound clip to be associated with the audiocon, which in one implementation may also include user-provided sound for the audiocon. In other embodiments the user may provide a video clip or animation for the audiocon.

If the lookup string does not match a system defined audiocon or a user-defined audiocon then in one embodiment an audio bubble is emitted with text-to-speech version of the lookup string (step 1150). That is, if the audiocon string does not match either of these, then an additional audio bubble can be emitted into the conversation stream that is the text-to-speech encoding of that text string.

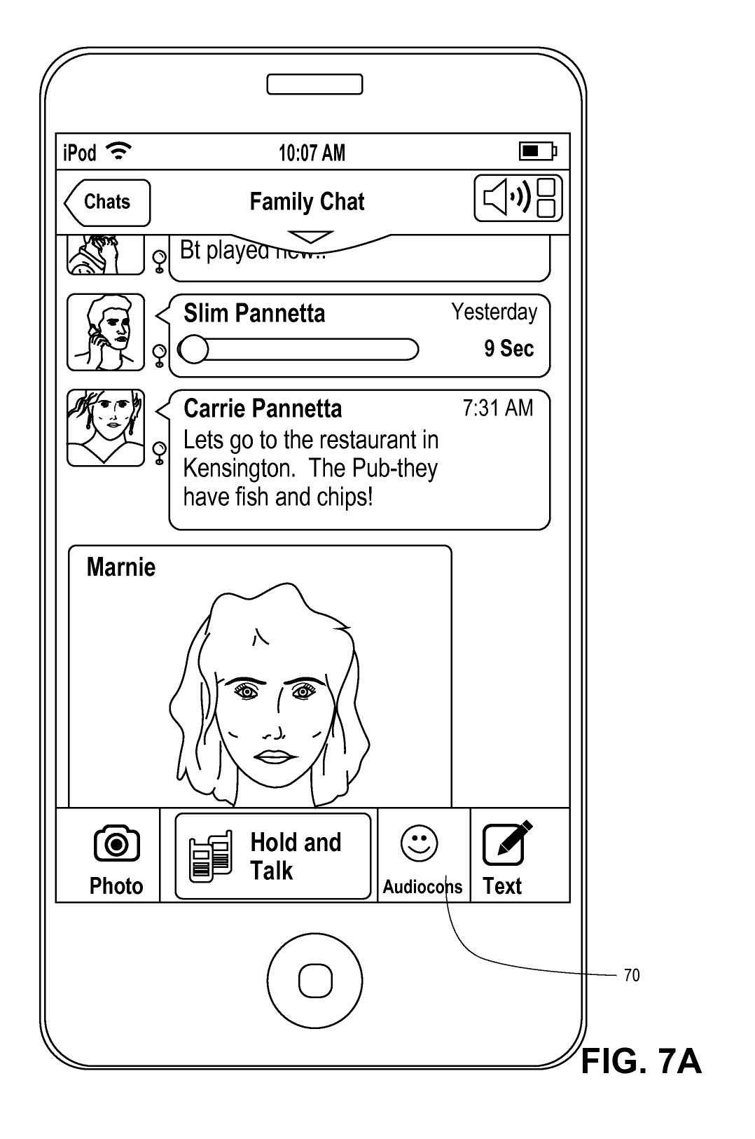

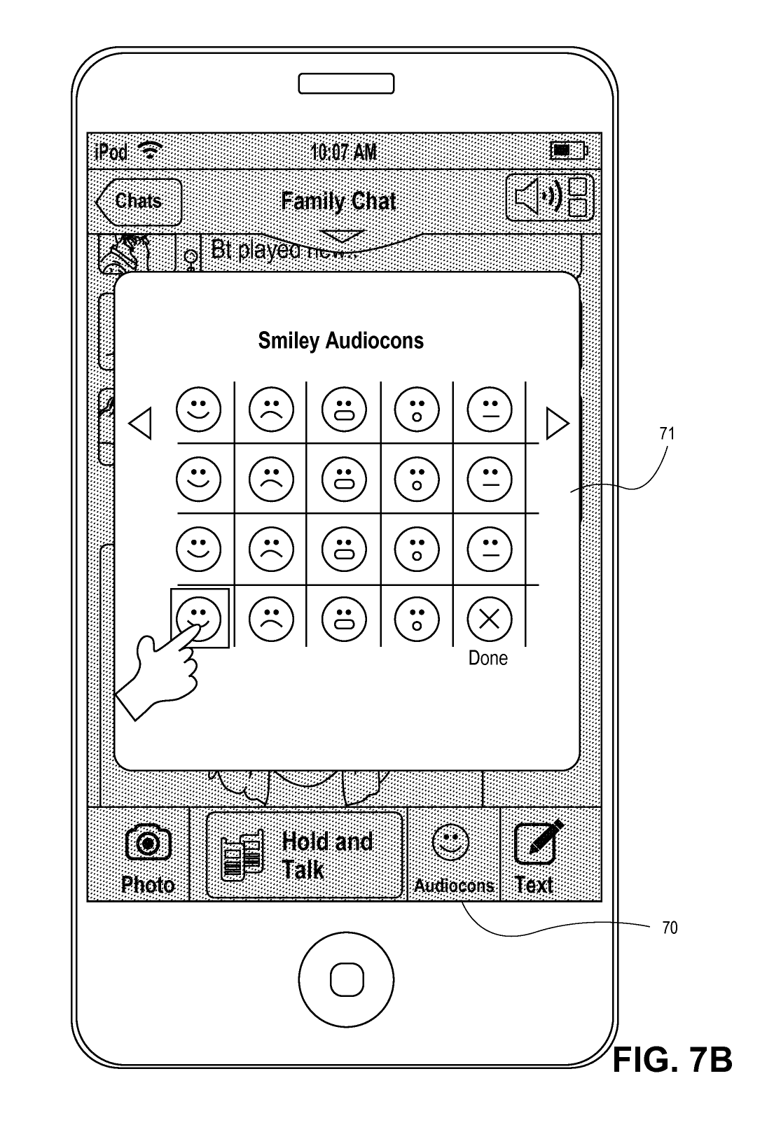

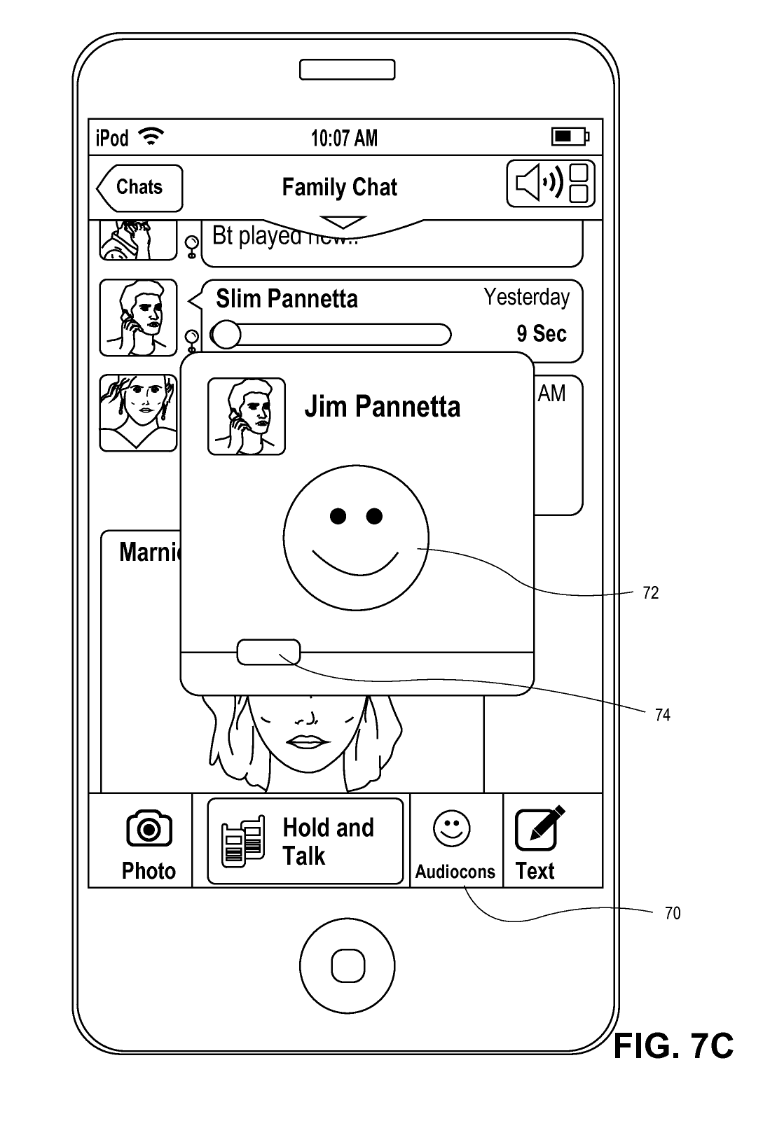

In an alternative embodiment, as illustrated in FIG. 7A, an “Audiocon” selection function 70 is displayed on the display screen 44 of the device 12. When the Audiocon function 70 is selected, a pop-up grid 71 including a library of audiocons, which may be either predefined or customized by the user, is displayed as illustrated in FIG. 7B. In various embodiments, the audiocons may be audio, video, pictures, animation, or any other type of media. Finally, referring to FIG. 7C, the audio and/or video of the selected audiocon is rendered on the client device 12 of the recipient. The audiocon may be rendered in real-time as the audiocon is transmitted and received on the device 12 of the recipient or sometime after receipt by retrieving and rendering the media of the audiocon from the PIMB 28 in a time-shifted mode. In this example, the graphic 72 of the audiocon is displayed and the associated audio is rendered, as indicated by the audio display bar 74. If the selected audiocon included video or any other media, then the video and other media would also have been rendered.

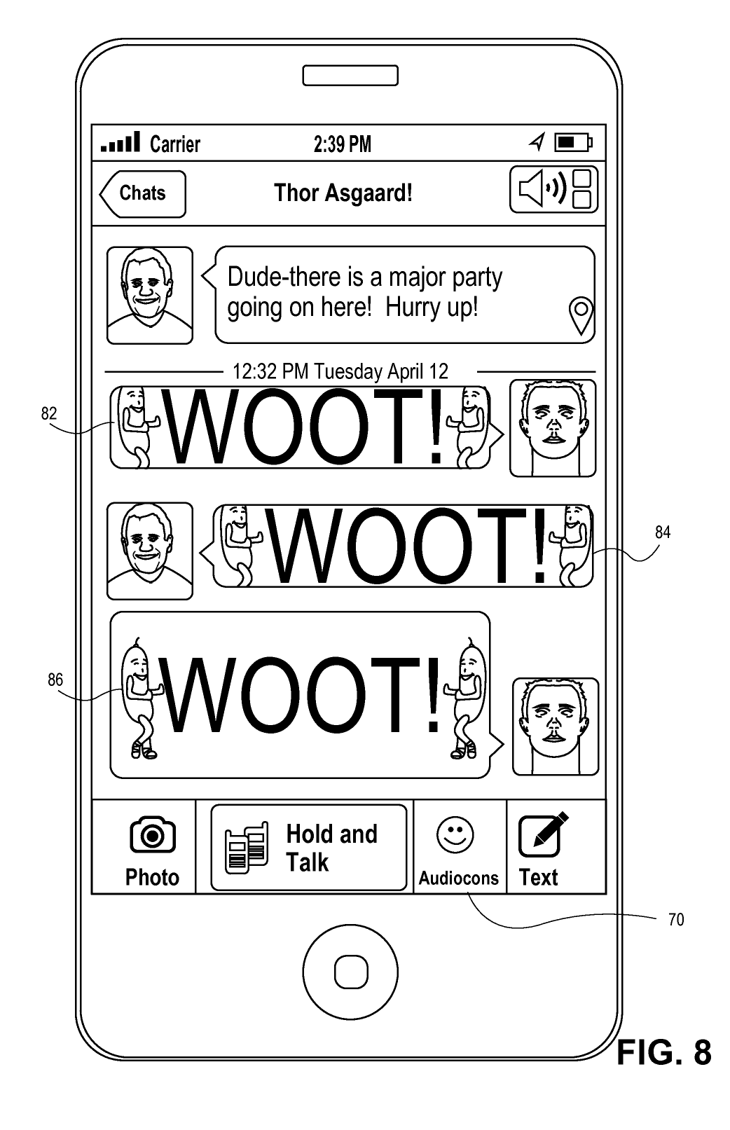

Regardless of how the audiocons are defined, once selected, they are inserted as media bubbles into the conversation history. Referring to FIG. 8, the graphics for an audiocon illustrating a dancing pickle and the text “WOOT” are inserted into the media bubbles of a conversation string between two participants conversing about a party. When any of the audiocons in the bubbles 82, 84 or 86 are selected, the audio and/or video associated with the audiocon is rendered. It should be understood that this example is merely illustrative. In various embodiments, a wide variety of audiocons can be defined and used, covering just about any emotion or topic. For example, cheers, boos, applause, special sound effects, and accompanying visuals and/or video, etc., could all be used. The variety of audiocons that can be used are virtually limitless, and therefore, as a matter of practicality, are not listed herein.

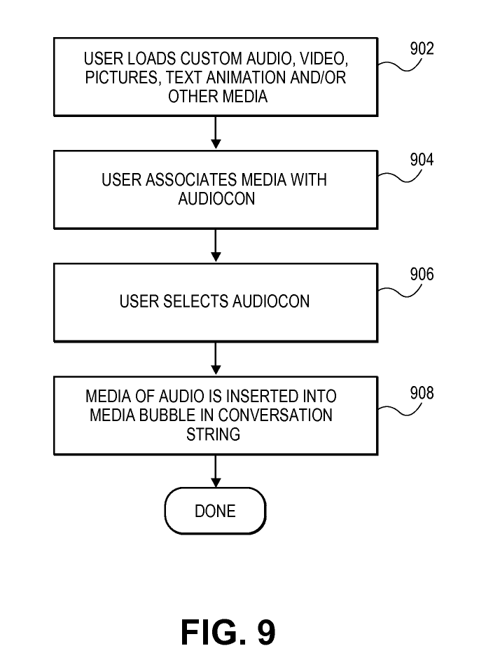

In various embodiments, audiocons can be made customizable by allowing users to create their own media, including custom audio, video, pictures, text, and/or animation and the audiocon used to represent the media. Referring to FIG. 9, a flow chart illustrating the steps for crating and using customized audiocons is illustrated. In the initial step (902), the user loads custom audio, video, pictures, text, graphics and/or animation (hereafter referred to as “media”) onto the client device 12. Thereafter, the user associates the uploaded media with an audiocon (Step 904), which is defined by the user. During operation, the user then selects an audiocon (step 906), either by entering a text string or selecting from the grid 71. The selected audiocon is then transmitted to the participants of the conversation and inserted into the conversation string (step 908).

By way of example, an audiocon “YT” (short for “You there”) can be created by a user such that the recipient hears a recording of the sender's voice saying, “Hey, are you there?” As another example, an audiocon MB (short for “my baby”) could be triggered such that the recipient sees a video clip corresponding to baby videos. In this example, the user would load a video clip onto the device for the audiocon. As yet another example, consider an animation of an airplane flying. The user would load the animation of the airplane onto the device, such that when the audiocon is triggered the recipient would see an animation of an airplane flying across a media bubble.

In an situations where the user is ‘playing through’ the conversation, the audiocon audio would be played as part of the conversation along with any other recorded audio for the conversation. For example, rather than explicitly stating “the preceding message is funny,” a user can select an audiocon for a laughter, which will display a graphical icon accompanied by the sound of laughter.

As previously described, in one embodiment an audiocon is inserted by inputting text between two delimiters or by selection of a library of audiocons from a grid. However, more generally to save users time while communicating, audiocons can also be inserted into a communication stream by selecting from a set of pre-made or custom audiocons via icon, button, menu, voice recognition, or other means. For example an icon showing a smiley face and two hands clapping could insert the audiocon representing applause, accompanied by an applause recording. Audiocons can also be embedded into an interactive communication string by means of encoding symbols, often referred to as ASCII art. For example, typing “:((” could represent crying, shown in code or with a graphic icon accompanied by playback of a crying sound. There are several differences between standard emoticons and audiocons in this example. First the inputting of the characters is not just an image but also results in an adjoining sound file or an animation with sound. The adjoining sound file (or animation with sound) can be customized by the user. Moreover, the audiocon can play as a voice shortcut. Additionally, in an alternate embodiment the audiocon plays in a media bubble separate from a text message.

Various techniques can be utilized for providing the audio and/or visuals associated with an audiocon to recipients. For example, the sounds (or other media for an audiocon can be stored on the devices of participants in advance or sent when the audio is needed. Additionally, a display can be generated for the sending user to show what audiocon options are available for other conversation participants along with what audiocon media can be used to converse with the other participants.

Audiocons can be provided for free as part of a communication service. Additionally, one or more features may be provided to end-users based on a purchase fee. For example, the software that includes the audiocon feature may include a free, basic set, and may offer more audiocons for purchase.

It will be understood throughout the previous discuss that the audiocons may be interjected into a communication stream and also be displayed on the sending device and also any recipient devices supporting audiocons. Both sending devices and receiving devices may utilize a similar method to that illustrated in FIG. 6 to parse a text string and emit appropriate audiocon bubbles on the display of a communication device. However, it will also be understand that other variations for a recipient device to detect the command for generating an audiocon could be employed such as converting, prior to transmission, the information of the command into a different form and sending that representation of the command to the recipient system.

Different user-interface techniques, such as shading or using different colors, bolding, etc., may also be used to contrast audiocons that have previously been played with messages that have not yet been reviewed. For example, on the recipient side, the sound can play instantly upon receipt in a “live” mode. However, if the recipient is not present to listen to the message live then it may be played by opening the media bubble or playing it along with other audio messages.

Referring to FIG. 8, note that one embodiment audiocons are emitted in media bubbles having a size selected to facilitate a user navigating through the communication history and viewing and opening audiocons in the communication history. For example, the audiocons may have a size comparable in at least one dimension to other bubbles used for voice or text messages in order to facilitate viewing and/or selecting an audiocon via a touch-screen display. Additionally, in one embodiment the size of the media bubble for an audiocon may be selected to be greater in at least one dimension than at least some of the text and voice bubbles, as illustrated in FIG. 7C.

Note that the audiocons of the present invention have many individual features not found in conventional emoticons. A conventional emoticon, such as a smiley, occupies a small portion of a text field within the same text block as a text message, does not have audio, is not customizable in terms of user-defined audio and/or visual content, and does not also have associated alpha-numeric text to describe the emotion of the emoticon. Moreover, a conventional emoticon does not provide a means to “open” the emoticon and indicate whether it has been consumed.

It will be understood throughout the following discussion that the application implementing the audiocon may be stored on a computer readable medium and executed on a local processor within the client communication device. It will also be understood that the audiocon may be implemented in different ways, such as part of a messaging system, messaging application, messaging method, or computer readable medium product. Additionally, while the use of audiocons has been described in relation to an exemplary messaging application and system, more generally it will be understood that audiocons may be practiced with communication applications and systems having features different than those described in section I of the detailed description of the invention.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention may be employed with a variety of components and methods and should not be restricted to the ones mentioned above. It is therefore intended that the invention be interpreted to include all variations and equivalents that fall within the true spirit and scope of the invention.

What is claimed is:

1. A computer program product comprising a messaging application embedded in a computer readable medium having computer readable code including:
computer code for determining if a command is an instruction to generate additional media content having audio representative of emotion, wherein the media content is selected from the group consisting of an audio file, a video file, and an animation; and
computer code for detecting the command and in response emitting into a communication stream a media bubble including the media content having audio representative of emotion.

2. The computer program product of claim 1, wherein the media content is emitted into a media bubble having a size comparable in at least one dimension to other bubbles used for voice or text messages.

3. The computer program product of claim 1, wherein further comprising:
computer code for receiving a media file from a user;
computer code for associating a command with the media file; and
computer code for generating a user-defined media bubble based on the user-provided media file and the associated command.

4. The computer program product of claim 1, wherein the command is selected from a library of commands.

5. The computer program product of claim 1, further comprising computer code to determine whether the command is to generate a system-defined media content or a user-defined media content.

6. The computer program product of claim 1, wherein the media content is a text-to-voice audio message.

7. The computer program product of claim 1, wherein the command comprises text within at least one delimiter.

8. The computer program product of claim 1, wherein the media content representative of emotion is emitted as a media bubble for expressing emotion that is separate from other bubbles used for text or voice messages.

9. The computer program product of claim 1, wherein the media bubble provides an indication to the recipient whether the media content has been consumed.

10. The computer program product of claim 1, wherein in a live mode the media content is played at a recipient device upon receipt and in time-delayed mode a recipient selects the media content to play it.

11. A method of expressing emotional content in a messaging environment, comprising:
determining if a command is an instruction to generate additional media content having audio representative of emotion, wherein the media content is selected from the group consisting of an audio file, a video file, and an animation; and
detecting the command and in response emitting into a communication stream a media bubble including the media content having audio representative of emotion.

12. The method of claim 11, wherein the media content is emitted into a media bubble having a size comparable in at least one dimension to other bubbles used for voice or text messages.

13. The method of claim 11, further comprising:
receiving a media file from a user;
associating a command with the media file; and
generating a user-defined media bubble based on the user-provided media file and the associated command.

14. The method of claim 11, wherein the command is selected from a library of commands.

15. The method of claim 11, wherein detecting the command determines whether the command is to generate a system-defined media bubble or a user-defined media bubble, wherein system-defined media content is played for a system-defined media bubble and a user-defined media content is played for a user-defined media bubble.

16. The method of claim 11, wherein the media content is a text-to-voice audio message generated based on text associated with the command.

17. The method of claim 11, wherein the command comprises text within at least one delimiter.

18. The method of claim 11, wherein the media content representative of emotion is emitted in a media bubble for expressing emotion that is separate from other bubbles used for text or voice messages.

19. The method of claim 11, wherein the media bubble provides an indication to the recipient whether the media content has been consumed.

20. The method of claim 11, wherein in a live mode the media content is played at a recipient device upon receipt and in time-delayed mode a recipient selects the media content to play it.

21. A messaging application embedded in a computer readable medium, the message application including:
a user interface;
a rendering module;
a database;
the messaging application supporting a communication stream into which additional audio media content representative of emotion may be inserted including at least one of system-defined media content and user-defined content.

22. The messaging application of claim 21, wherein the media content includes media selected from the group consisting of an audio file, a video file, and an animation.

23. The messaging application of claim 21, wherein the messaging application detects a command for generating the media content in a text message and the additional media content is emitted as a media bubble.

24. The messaging application of claim 21, where the messaging application detects a command for emitting media content representative of emotion within a text string.

25. The messaging application of claim 21, wherein the messaging application is configured to receive a media file from a user; associating a command with the media file; and generate a user-defined media bubble based on the user-provided media file and the associated command.

26. A method of expressing emotional content in a messaging environment, comprising:
determining if a command is an instruction to generate additional media content having audio representative of emotion; and
detecting the command and in response emitting into a communication stream a media bubble including the media content having audio representative of emotion.

27. A computer program product comprising a messaging application embedded in a computer readable medium having computer readable code including:
computer code for determining if a command is an instruction to generate additional media content having audio representative of emotion; and
computer code for detecting the command and in response emitting into a communication stream a media bubble including the media content having audio representative of emotion.
